(19) United States
(12) Patent Application Publication
(10) Pub. No.: US 2005/0169252 A1
(43) Pub. Date: Aug. 4, 2005

(54) Game controller including an integrated communicator

(76) Inventor: Andrew Riggs, Lewisville, TX (US)

Correspondence Address: Bell, Boyd & Lloyd LLC, P.O. Box 1135, Chicago, IL, 60690-1135, US

(21) Appl. No.: 11/046,369

(22) Filed: Jan. 28, 2005

Related U.S. Application Data
(60) Provisional application No. 60/541,664, filed on Feb. 3, 2004.

(51) Int. Cl. H04L 12/66

(52) U.S. Cl. 370/352

(57) ABSTRACT

A game controller including a housing, a first processor mounted in the housing and an audio input connected to the housing and in communication with said first processor. The audio input being adapted to receive an audio communication, convert the audio communication to at least one control signal and communicate the control signal to the first processor. The game controller also includes an interface coupled to the housing, where the interface is a game control such as a directional pad or joystick. The game controller is adapted to communicate at least one control signal from the first processor to a second different processor via the internet, and is adapted to receive at least one control signal from the second processor via the internet.

### PRIORITY CLAIM

This application is a non-provisional patent application and claims priority to and the benefit of U.S. Provisional Patent Application Ser. No. 60/541,664, filed Feb. 3, 2004, the entire contents of which are incorporated herein.

### BACKGROUND OF THE INVENTION

The present invention relates to a video game controller that has a communicator chip integral to its circuitry. More particularly, the present invention relates to a video game controller that has an integral computer chip and a port to directly receive a communicator such as a headset, thereby allowing conversation through the controller hardware and over the internet.

Several prior art game systems have used Voice over Internet Protocol (VoIP) or Internet telephony technology. Generally, Internet telephony technology refers to communications services-voice, facsimile, and/or voice-messaging applications-that are transported via the Internet, rather than the public switched telephone network (PSTN). The basic steps involved in originating an Internet telephone call are conversion of the analog voice signal to digital format and compression/translation of the signal into Internet protocol (IP) packets for transmission over the Internet. The process is reversed at the receiving end.

VoIP allows you to make telephone calls using a computer network, over a data network like the Internet. VoIP converts the voice signal from your telephone into a digital signal that travels over the internet then converts it back at the other end so you can speak to anyone with a regular phone number. When placing a VoIP call using a phone with an adapter, you'll hear a dial tone and dial just as you always have. VoIP may also allow you to make a call directly from a computer using a conventional telephone or a microphone.

The possibility of voice communications traveling over the Internet, rather than the PSTN, first became a reality in February 1995 when Vocaltec, Inc. introduced its Internet Phone software. The software is designed to run on a 486/33-MHz (or higher) personal computer (PC) equipped with a sound card, speakers, microphone, and modem (see FIG. 1), the software compresses the voice signal and translates it into IP packets for transmission over the Internet. This PC-to-PC Internet telephony works, however, only if both parties are using Internet Phone software.

VoIP, is also referred to as, Voice over Network (VON), Internet Telephony, and Telephony over the Internet. See, e.g., G. Held, Voice over Data Networks, Mc-Graw-Hill Series on Computer Communications (McGraw-Hill Publ.: 1998), entire book; and T. Sheldon, Encyclopedia of Networking, Electronic Edition, (Mcgraw-Hill Publ.: 1998), pp. 1047-1050. Both of these references are incorporated in their entirety herein by reference. A PSTN is also referred to as a plain old telephone system (POTS). A PSTN can include transmission components (links), switching components (nodes), and billing facilities. See, e.g., Held, chapter 4, “Understanding Voice” and chapter 5, “Telephone Operations,” and Sheldon at pp. 959-968. The Internet can be any network or combination of networks that support packet-switching. Such a network can include, but is not limited to, a network supporting the Internet Protocol (IP) and related protocols. See, e.g., Held, chapter 2, “IP and Related Protocols,” and Sheldon, pp. 503-543.

VoIP systems allow a call originating from a PSTN to be carried over the Internet. In this way, voice traffic can be carried over the Internet bypassing more expensive long-distance carriers. For example, Toll Bypass Carrier services, multi-site corporations, and other users use VoIP systems to reduce the cost of long distance telephone calls to a fraction of one cent per minute.

A VoIP system typically relies on gateways to provide an interface between PSTN and IP networks. A user picks up a telephone and dials a phone number of a phone. The called party phone answers, and connection is then established through gateways over an IP network. Voice, fax, and data transmission is then carried out between the phones through this connection. In this way, an expensive long-distance carrier on a PSTN can be bypassed.

A local PBX (private branch exchange) system can also place a call originating from a phone over a PSTN to a local originating gateway. Note the gateways referred to herein as originating and destination gateways for convenience only. In practice, full-duplex communication is carried out and either phone can originate or receive a call. Also, the PBX system is programmed to automatically (and selectively) route certain calls from a phone to a gateway. In this way, a user can dial the destination phone number directly in one step. Alternatively, if no PBX or other special pre-configuration at a local exchange carrier (LEC) is performed, a two step process is used where a user calls a gateway directly and then in response to a prompt from the gateway enters the destination phone number of a phone.

Next, the gateway contacts the destination gateway over the IP network. The destination gateway dials the destination phone number over a PSTN line to the destination phone. The Gateway then packetizes the voice stream from the PSTN and routes it over the IP network to the destination gateway. The destination gateway converts the data packets into a voice stream and sends it over a PSTN line to the called party at a phone. By strategically locating gateways in desired calling areas long-distance costs are substantially reduced. Indeed, a long-distance call is essentially replaced by two local phone calls and a low cost IP connection.

Video game consoles are now equipped with appropriate hardware and software to accommodate those who want to play with or compete with players in other locations via the Internet. In addition to being able to play video games over the Internet, voice communication can be established between players using VoIP, allowing them to have conversations during play. An added feature is that individuals who have the appropriate equipment can have remote conversations without playing games, becoming in essence, a long distance phone service at a reasonable cost.

These video game consoles utilize a separate piece of hardware that plugs into the port of an existing pad and/or directly into a video game console. Earphones and/or microphones of various designs are also typically included in the set. The console provides the interface with the Internet and the Internet service can also be provided by the console manufacturer. The hardware, however, must be purchased separately. Additionally, the piece of hardware may be lost or damaged during use.

Accordingly, there is a need for improved video game equipment and accessories which are easily transportable and enhance game play and which minimizes the cost and burden of purchasing separate hardware for video game systems.

### SUMMARY OF THE INVENTION

The present invention is directed to a game controller used with a video game system such as XBOX® or PlayStation® systems. The game controller includes an integrated communicator that enables players to communicate with each other during game play.

In one embodiment, the game controller or game pad of the present invention is directed to a housing, a first processor such as a chip mounted in the housing and an audio input connected to the housing and in communication with the first processor. The audio input is adapted to receive at least one audio communication, convert the audio communication to at least one control signal and communicate the control signal to the first processor. The game controller includes an interface coupled to the housing, where the first processor is adapted to receive and communicate the control signal from the first processor to a second different processor via the internet, and receive at least one control signal from the second processor via the internet.

In an embodiment, the first and/or the second processor of the game controller includes a chip. It should be appreciated that the first and/or the second processor may be a computer chip or chip, a circuit board, a microprocessor, or any suitable processor.

In one embodiment, the audio input is adapted to receive a voice communicator. In another embodiment, the voice communicator includes at least one of a microphone and a speaker on a headset. It should be appreciated that the voice communicator may be any suitable communicator such as a headset. In one embodiment, the audio input of the game controller includes a wireless communicator, where the wireless communicator is operable to communicate with a wireless voice communicator such as a wireless headset.

The game controller may include at least one of the following interfaces or inputs: an analog stick, a directional pad and an action button. The game controller may also include at least one mute button, a volume control and an indicator light. The indicator light indicates when the game controller is turned on or activated. It should be appreciated that the indicator light may be any suitable light and may indicate or display any suitable function or functions associated with the game controller. It should also be appreciated that the indicator light may be any suitable color or colors.

In another embodiment, the game controller or control pad includes a housing, a communication chip adapted to facilitate voice communication via the internet disposed within the housing, and an interface coupled to the housing and adapted to communicate control signals to the video game system.

In an embodiment, the interface is selected from a group consisting of an analog stick, a directional pad and an action button.

In an embodiment, the game controller includes circuitry such as suitable electrical wiring electrically coupled to the communication chip.

In another embodiment, the communicator chip is integral with a circuit board.

In an embodiment, the voice communication is communicated via a microphone.

In another embodiment, the housing includes an output port for transmitting the voice communication from the game controller or the control pad to the video game system.

In an embodiment, the game controller or control pad is adapted to receive voice communication.

In another embodiment, the game controller includes a housing including an input port for receiving voice communications via the video game system.

In another embodiment, the video game controller includes a control pad or control console for inputting instructions to a video game and electronic circuitry such as wiring. The game controller includes a communicator device which is adapted to facilitate data transmission via the internet. The game controller includes at least one of an audio input jack and an audio output jack.

In an embodiment, the communicator device is integral with a circuit board.

In another embodiment, the data transmission is communicated via a microphone.

In another embodiment, the game controller is in communication with a video game system. The game controller includes a pad, an electrical system supported by the pad, and at least one control device in electrical communication with the electrical system for inputting commands to the video game system and a communication device for transmitting voice across the internet in electrical communication with the electrical system.

In an embodiment, the communication device includes a chip.

In another embodiment, the communication device includes a microphone.

In an embodiment, the game controller includes an output port for transmitting the voice from the pad to the video game system.

In another embodiment, the game controller is adapted to receive voice communications.

In an embodiment, the game controller includes an input port for receiving the voice communications via the video game system.

In a further embodiment, a method of transmitting data over the internet is provided where the method includes transmitting the data to a first video game controller and converting the data using a chip mounted in the video game controller such that the data is suitable for transmission via the internet. The method includes transmitting the information across the internet, and receiving the data with a second video game controller.

In an embodiment, the method includes transmitting the data to the first video game controller using a microphone.

In another embodiment, the method includes receiving the data from the second video game controller using a speaker.

Accordingly, an object of the present invention is to provide a game controller including an internet based communicator for video game players.

Another object of the present invention is to provide a game controller that has a communicator chip integral to its circuitry.

Another object of the present invention is to provide a game controller that eliminates the need for external hardware to enable video game players to communicate verbally with each other.

Additional features and advantages of the present invention are described in, and will be apparent from, the following Detailed Description of the Invention and the figures.

### BRIEF DESCRIPTION OF THE FIGURES

FIG. 1 is a top perspective view of one embodiment of a game controller of the present invention.

FIG. 2 is a rear perspective view of the game controller of FIG. 1.

FIG. 3A is a front perspective view of one embodiment of a headset connectable to the game controller of FIG. 1.

FIG. 3B is a front perspective view of the headset of FIG. 3A connected to the game controller of FIG. 1.

FIG. 4 is a front perspective view of one embodiment of an input of the game controller of FIG. 1.

FIG. 5 is a front perspective view of one embodiment of a volume adjuster of the game controller of FIG. 1.

FIG. 6 is a front perspective view of one embodiment of a light source associated with the game controller of FIG. 1.

### DETAILED DESCRIPTION OF THE INVENTION

The present invention is directed to a game controller used with a video game system such as an XBOX® or PlayStation® video game system. The game controller includes an integrated communicator that enables players to communicate with each other during game play.

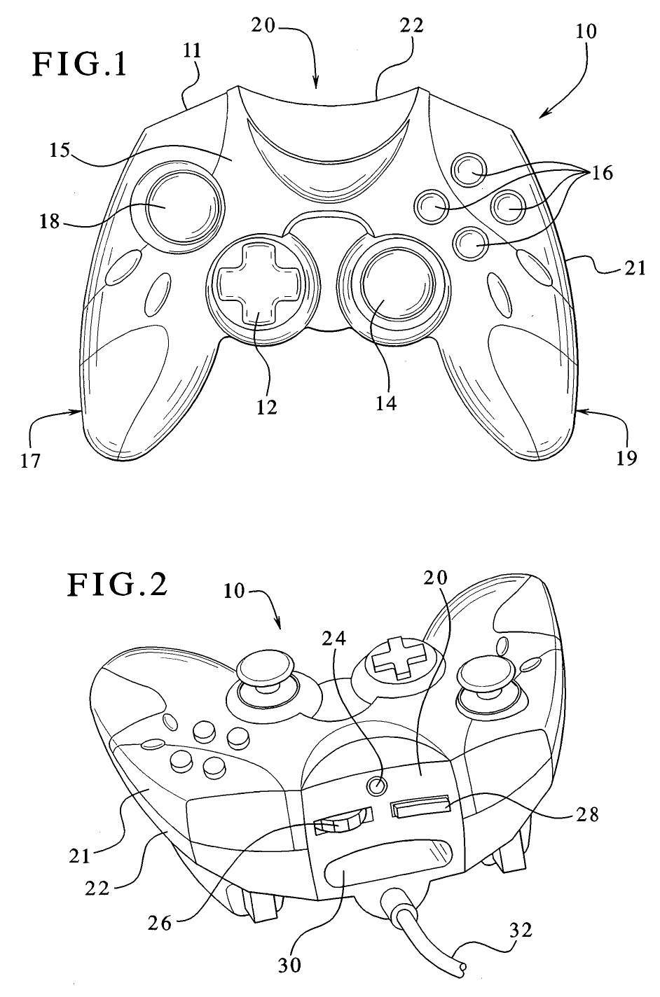

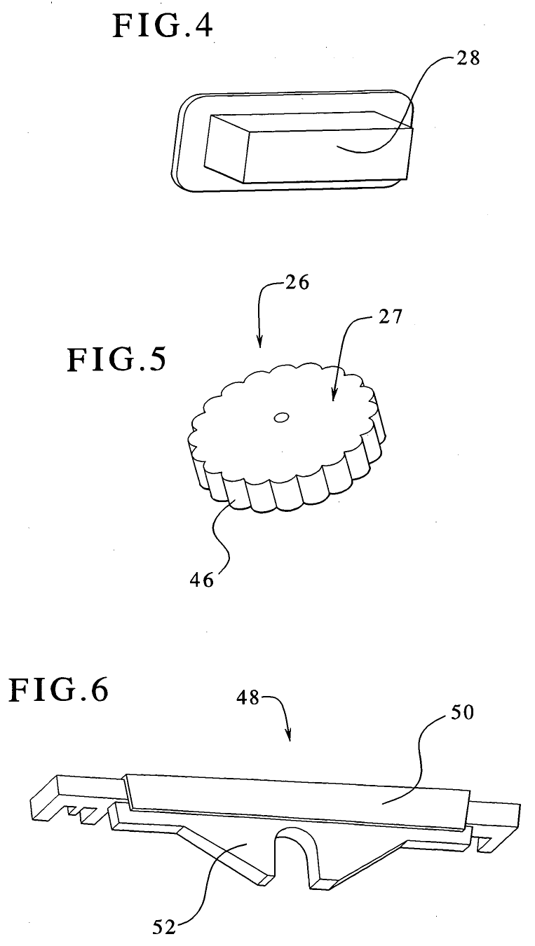

Referring now to FIGS. 1 to 6, in one embodiment, the present invention provides an electronic video game controller 10 including an integrated communicator which enables one or more players to communicate over a communication system or network such as the internet. The game controller 10 is preferably a hand held game controller for a conventional game system such as PLAYSTATION 2®, XBOX®, GAMECUBE®, or any other similar game system. However, the present invention can be used with any other game system or any suitable type of hand held electronic game. The game controller 10 of the present invention operates a video game system. In particular, game controller 10 communicates with a console (not shown) of the video game system to operate the game, as is well known in the art. Generally, game controller 10 includes a housing 11 that includes at least one input such as directional input 12, analog sticks or joysticks 14 and 18, and four action inputs or buttons 16. It should be appreciated that the game controller 10 may include one or a plurality of inputs or input devices.

The game controller supports electronics therein including a processor or microprocessor (not shown), which communicates with game software (not shown) of a console, typically by an electrical connection such as electrical wiring or a wireless connection. More specifically, inputs 12, 14, 16 and 18 output analog data corresponding to a direction, e.g. up, down, right, left and the like, or another function of a game as the inputs are activated or operated by a player of the video game. The analog data from the inputs is converted to digital data or control signals and sent to the processor of the game controller 10 which in turn communicates with the video game software for operating the game.

The game controller or control pad 10 preferably has the general appearance of a conventional controller for a game system, such as the PLAY STATION 2®, the XBOX® or the GAME CUBE® video game systems. However, the game controller or game pad can have any desired shape or configuration. The game controller or control pad preferably includes a body portion 15, a first handle portion 17 and a second handle portion 19, and is formed of an upper or top plastic housing 21 and a lower or bottom plastic housing 22. It should be appreciated that the housing may be made or manufactured using any suitable material or materials.

In the illustrated embodiment, the first handle portion 17 generally supports directional control pad 12, the second handle portion 19 supports action buttons 16 and the body portion 15 supports both the right analog stick 14 and the left analog stick 18. However, as noted above, the inputs or controls can be positioned in any manner desired. Furthermore, the game controller 10 can have as many or as few inputs, controls or control devices disposed thereon. In other words, this invention is not limited to the specific number of action buttons, analog sticks and directional pads noted above, the present invention can have as many control devices (or as few) as desired. It should be appreciated that the game controller 10 can have any suitable number of additional inputs or control devices.

In one embodiment, the game controller 10 includes an accessory slot 30 defined by the game controller housing. The accessory slot is adapted to receive one or more accessories such as game cartridges, other controllers and the like. It should be appreciated that the game controller may include one or more accessory slots.

In one embodiment, the game controller includes a communication cable 32 which transfers signals such as electronic signals associated with the functions of a game between the game controller and a game console or system. The communication cable may be any suitable cable, wire or communication device. In another embodiment, the game controller includes a wireless communicator which enables the game controller to communicate with a game system without having the cable 32.

In the illustrated embodiment, the game controller or control pad includes at least one audio input 24 located on a rear surface 20 of the game controller. The audio input 24 is a receptacle which extends into the housing. In another embodiment, the game controller includes one or more audio inputs. It should be appreciated that the audio input 24 may be located on any suitable portion or surface of the game controller. It should also be appreciated that the audio input may be adapted to send voice or sound communications, receive voice or sound communications or send and receive voice or sound communications. In one embodiment, a communicator device is encased or housed between the upper and lower housing portions, 21 and 22. The communicator device includes a processor and a communicator chip or circuit board integral to its circuitry or with a PC board. The audio input 24 is connected to the PC board which eliminates the need for purchasing and using external hardware to perform such communication. The circuitry for electrically connecting the audio input or port and the communicator chip can be any suitable circuitry such as any suitable electrical wiring or cables. Additionally, the communicator chip can be any suitable device that would allow communication via a voice communicator such as a headset through the controller and over the internet to another different controller and/or headset or other communication device.

The controller does not necessarily need one audio input. The game controller can be equipped with an audio input, a plurality of audio inputs, a separate audio input and audio output or a plurality of separate audio inputs and outputs.

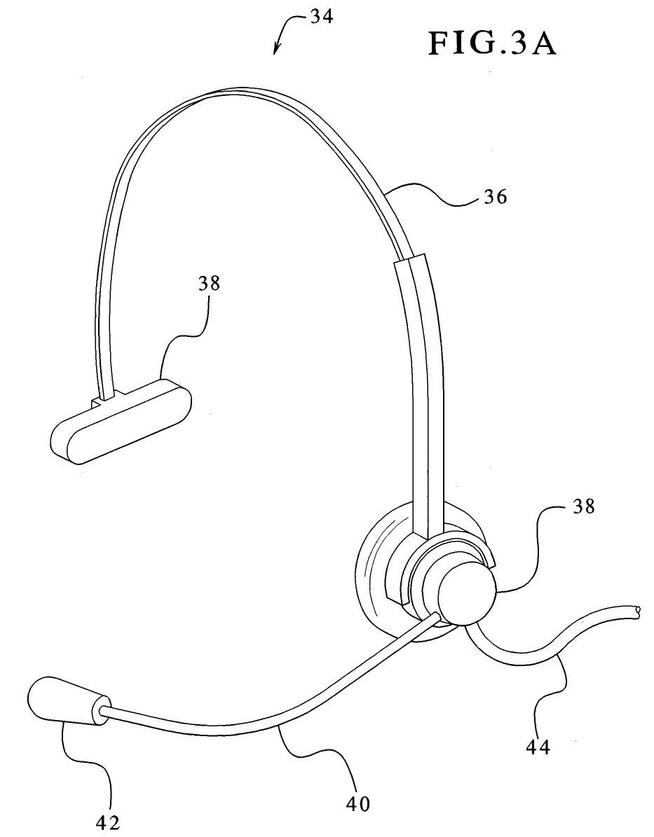

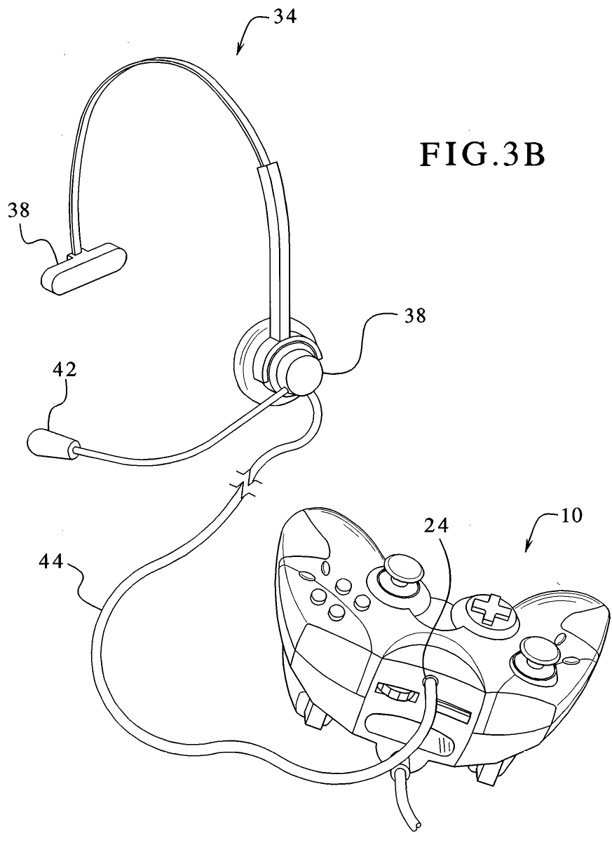

Referring to FIGS. 3A and 3B, the present invention requires only an audio communicator such as a headset 34 including at least one of a microphone 42 and a speaker 38 to enable players of video games to communicate verbally with each other while playing (or not playing) games in their respective, separate locations. The microphone is connected to the audio system using an extender 40. The extender 40 enables a user to be able to adjust the location and comfort of the microphone. Similarly, the headset includes an extender or bracket 36 which is connected to at least one speaker 38. The bracket 36 enables the user to be able to adjust the position and comfort of the speaker 38. As illustrated in FIG. 3B, at least one communication line or wire 44 is connected to the headset 34 and enables the headset to plug into or insert into the audio input 24 located on the rear side of the game controller. In another embodiment the headset includes a wireless communicator which enables the headset to transfer audio signals to and from the game controller or game system without wiring or other suitable connectors. It should be appreciated that the audio input may be positioned in any suitable portion on the housing. It is noted that the present invention can support a microphone only, a speaker only or a system using both a microphone and a speaker, or any other system designed to communicate to a separate location.

On the top portion 21 of the housing 11 the game controller includes an indicator such as a light or Light Emitting Diode (LED) 48 (best illustrated in FIG. 6) including light 50 and electrical support or contact 52 that illuminates or lights up or glows in a specific color to indicate that the power of the game controller is on or that the game controller is activated. Additionally, the light illuminates in a specific color or colors to indicate specific functions of the game controller. For example, in one embodiment, the light glows green when the game controller is activated or turned on.

The game controller or game pad including the integrated communicator offers the advantage of being lighter in weight and more portable than existing game controllers. Additionally, the only external hardware employed by the game controller of the present invention is the voice communicator or headset (including the microphone and the speaker or ear piece) that is inserted into or plugs directly into the audio input or audio jack 24 of the game controller. The game controller is therefore easier to use and can be easily used with other consoles or video game systems which do not include the communicator or chips which enable the communication of audio expressions over the internet. Additionally, the game controller of the present invention minimizes the cost and burden of purchasing separate external hardware to perform the communication function.

In one embodiment, the game controller includes a mute input, mute switch or mute button 28 which enables a user to mute, silence or stop any audio communication from being communicated from the speaker or other audio device to the user. The mute button 28 may be any suitable input, button or switch such as a conventional button or any other conventional switch, button or input.

The game controller 10 also includes a volume control or audio or volume adjuster 26, and can have other controls, indicator lights, and outputs added to enhance performance of the game controller. In one embodiment, the volume adjuster 26 includes a rotatable member such as a dial 27 which includes knurls or curves 46 formed on at least one surface of the dial. The knurls 46 enable a user to better control and selectively rotate or move the dial to adjust the volume of the communications received by the game controller.

In one embodiment, the integrated communicator includes at least one of an integrated chip, a processor, a micro-processor, a chip or any other suitable communicator. It should be appreciated that the interface can be manufactured to interface with various different brands of consoles or video game systems.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A control pad for video game systems, comprising
a housing;
a communication chip adapted to facilitate voice communication via the internet disposed within said housing; and
an interface coupled to said housing and adapted to communicate control signals to said video game system.

2. A control pad according to claim 1, wherein
said interface is selected from a group consisting of an analog stick, a directional pad and an action button.

3. A control pad according to claim 1, further comprising
circuitry electrically coupled to said communication chip.

4. A control pad according to claim 1, wherein
said communicator chip is integral with a circuit board.

5. A control pad according to claim 1, wherein
said voice communication is communicated via a microphone.

6. A control pad according to claim 1, wherein
said housing includes at least one output port for transmitting said voice communication from said control pad to said video game system.

7. A control pad according to claim 6, wherein
said control pad is adapted to receive voice communication.

8. A control pad according to claim 7, wherein
said housing includes at least one input port for receiving voice communications via said video game system.

9. A control pad according to claim 8, wherein
said interface is selected from a group consisting of an analog stick, a directional pad and an action button.

10. A control pad according to claim 1, wherein
said control pad is adapted to receive voice communications.

11. A control pad according to claim 9, wherein
said housing includes at least one input port for receiving voice communications via said video game system.

12. A video game controller, comprising:
a control pad for inputting instructions to a video game;
electronic circuitry, including a communicator device adapted to facilitate data transmission via the internet; and
at least one of the following:
an audio input jack; and
an audio output jack.

13. A video game controller according to claim 12, wherein
said control pad includes at least one of the following: an analog stick, a directional pad and an action button.

14. A control pad according to claim 12, further comprising
said communicator chip is integral with a circuit board.

15. A control pad according to claim 12, wherein
said data transmission is communicated via a microphone.

16. A control pad according to claim 12, wherein
said video game controller includes at least one audio output jack and an audio input jack.

17. A control pad according to claim 16, wherein
said video game controller includes at least one of the following: an analog stick, a directional pad and an action button.

18. A video game controller in electrical communication with a video game system, the controller comprising:
a pad;
an electrical system supported by said pad;
at least one control device in electrical communication with said electrical system for inputting commands to the video game system;
a communication means for transmitting voice across the internet in electrical communication with said electrical system.

19. A video game controller according to claim 18, wherein
said communication means includes a chip.

20. A control pad according to claim 19, wherein
said communication means for transmitting voice includes a microphone.

21. A control pad according to claim 18, wherein
said pad includes an output port for transmitting said voice from said pad to said video game system.

22. A control pad according to claim 21, wherein
said control pad is adapted to receive voice communications.

23. A control pad according to claim 22, wherein
said pad includes an input port for receiving said voice communications via said video game system.

24. A method of transmitting data over the internet, including the steps of
transmitting the data to a first video game controller;
converting the data using a chip mounted in the video game controller, such that the data is suitable for transmission via the internet,
transmitting the information across the internet, and
receiving the data with a second video game controller.

25. A method according to claim 24, further comprising the step of
transmitting the data to the first video game controller using a microphone.

26. A method according to claim 25, further comprising the step of
receiving the data from the second video game controller using a speaker.

27. A game controller comprising
a housing;
a first processor mounted in said housing;
an audio input connected to said housing and in communication with said first processor, said audio input adapted to receive an audio communication, convert the audio communication to at least one control signal and communicate the control signal to said first processor; and
an interface coupled to said housing,
wherein said first processor is adapted to receive and communicate the control signal to a second different processor via the internet, and
wherein said first processor is adapted to receive at least one control signal from said second processor via the internet.

28. The game controller of claim 27, wherein the first processor includes a chip.

29. The game controller of claim 27, wherein the first processor includes a circuit board.

30. The game controller of claim 27, wherein the audio input is adapted to receive a voice communicator.

31. The game controller of claim 30, wherein the voice communicator includes at least one of a microphone and a speaker.

32. The game controller of claim 30, wherein the voice communicator includes a headset.

33. The game controller of claim 30, wherein the voice communicator includes at least one of a microphone and a speaker.

34. The game controller of claim 27, wherein the audio input includes a wireless communicator, said wireless communicator operable to communicate with a wireless voice communicator.

35. The game controller of claim 34, wherein the wireless communicator includes a wireless headset.

36. The game controller of claim 27, wherein the interface includes at least one of the following: an analog stick, a directional pad and an action button.

37. The game controller of claim 27, which includes at least one of the following:
a mute button, a volume control and an indicator light.
